(19) United States
(12) Patent Application Publication
(10) Pub. No.: US 2006/0148356 A1
(43) Pub. Date: Jul. 6, 2006

(54) Quick-drying pure cotton fabric with two faces having different properties and a method of producing same

(75) Inventors: Yugao Zhang, Guangdong Province (CN); Jun Xiao, Guangdong Province (CN); Liming Zhou, Guangdong Province (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Guangdong Esquel Textiles Co., Ltd.

(21) Appl. No.: 11/369,264

(22) Filed: Mar. 6, 2006

Related U.S. Application Data
(63) Continuation-in-part of application No. PCT/CN05/00558, filed on Apr. 22, 2005.

(30) Foreign Application Priority Data
May 21, 2004 (CN) 200410027297.7

(51) Int. Cl. D04B 21/00; D04B 1/14; B32B 5/26

(52) U.S. Cl. 442/310; 442/304; 442/318

(57) ABSTRACT

The present invention is a quick-drying pure cotton fabric whose two faces have different properties and a method of producing same. One face of said fabric is a hydrophobic face formed largely or entirely from hydrophobic pure cotton, and the other face is a hydrophilic face formed largely or entirely from hydrophobic pure cotton. Moreover, said fabric is capable of unidirectional transportation of water. The method of producing said fabric consists mainly of separate hydrophobic treatments of pure cotton yarn. The result is hydrophilically-treated yarn and hydrophobically treated yarn. Then the two types of yarn are knit according to a certain knitting process to produce a fabric whose two faces have different properties: hydrophilicity and hydrophobicity. The fabric is also comfortable and has moisture management and fast-drying functions.

### FIELD OF THE INVENTION

The present invention relates to a type of pure cotton fabric and a method of producing same. In particular, it refers to a type of quick-drying pure cotton fabric whose two faces have different properties and a method of producing same. As defined in the present invention, the “two faces” can refer to either the obverse and reverse faces of a single knit fabric or to the inner and outer layers of a double knit fabric.

### BACKGROUND OF THE INVENTION

As the quality of life continues to improve and the textile industry develops, consumers expect clothing to keep on improving in all its aspects, including comfort, functionality, appearance, and feel. Therefore, the production of textiles that are comfortable and that have certain functionalities is the future trend of the textile industry.

Consumers strongly favor natural fiber textiles, especially pure cotton fabrics, for their comfort and environmental benefits. Pure cotton fibers generally have better absorbency, but after absorbing moisture they stick to the skin and cause the wearer to feel uncomfortable. Therefore, it would be very practical to produce a moisture management textile that could dry quickly, that would be dry and comfortable to wear, and that would be pleasing to the touch.

There are two main types of moisture management fabrics now on the market:

The first type of fabric is knit from differential fibers, like duct-containing polyester fibers, of which DuPont's Coolmax® and Taiwan's Coolplus are well-known examples. These fibers are functional synthetic fibers with a unique four-channel design. These channels can quickly convey sweat and moisture to the outer layer of the fabric. They therefore have good moisture management properties. However, knit fabrics that are produced using this type of functional fiber have a certain drawback. Theoretically, the fibers are designed to have four channels, which transport water or perspiration by means of a capillary effect. Once these channels are blocked, their moisture management performances suffer. Actually, these fibers are dyed using dispersed dyes at 100-130° C. Some oligomers in fibers dissociate under high temperatures and bind onto the fibers, thus blocking the channels and causing a drop in moisture management performance. In addition, these functional fibers are synthetic fibers. Therefore, fabrics knit from 100% functional fibers of this type will lack the soft feel of cotton fabrics. If one uses a blended yarn processed from cotton fibers and functional fibers of this type, it will suffer from such defects as severe hairiness and poor color fastness. After several home launderings, the knit fabrics made from such yarn will normally have lots of surface hair and show obvious color fading. In particular, flat-knit collars will deform significantly after washing. They will also have lower moisture management performance after washing.

The second kind of fabric achieves improved moisture management and dry comfort ability through blended spinning or knitting of synthetic fibers and cotton. Actual results show that this kind of fabric is stronger in moisture absorption ability and is less strong in quick drying performance. In addition, this kind of fabric also needs to make use of synthetic fibers and is thus not so comfortable or environmentally friendly.

Therefore, there is definitely a need to produce a pure cotton moisture management fabric that dry quickly, that is dry and comfortable to wear, that is pleasing to the hand feel and pleasing to the eye, and that holds up well under repeated washings.

### SUMMARY OF THE INVENTION

The present invention provides a type of quick-drying pure cotton fabric whose two faces have different properties. The combination of two faces with different properties in one fabric endows the fabric with the advantages of synthetic fibers—moisture management and quick drying—while maintaining the characteristics of pure cotton fabric—comfortable to wear, pleasing to the touch, good shape retention, good durability, and quick drying.

To achieve the above-described goals, the fabric provided by the present invention is pure cotton whose two faces have different properties. One face of said fabric is the hydrophobic face, formed from yarn that is largely or entirely hydrophobic pure cotton yarn. The other face is the hydrophilic face, formed from yarn that is largely or entirely hydrophilic pure cotton yarn. In addition said fabric can transport water unidirectionally.

When we compare the above-described quick-drying pure cotton fabric with two differently-propertied faces provided by the present invention with products of the current art, we find that the most important characteristic is that the two faces (or the inner and outer layers) of the fabric have different properties. That is, one face is hydrophobic, and the other face is hydrophilic. After it has undergone the appropriate knitting, it becomes a new type of pure cotton fabric that can achieve unidirectional transportation of water. Therefore, the two faces described in the present invention can be the obverse and reverse faces of a single knit fabric. They can also be the two layers of a fabric with a double knit-structure fabric.

According to a preferred scheme of the present invention, the hydrophobic face and the hydrophilic face of said pure cotton fabric are knitted from pure cotton yarn that has undergone separate hydrophobic and hydrophilic treatments. The yarn that is used to form the hydrophobic face should preferably contain from 60% to 100% hydrophobically-treated yarn and from 0% to 40% hydrophilically-treated yarn. The yarn used to form the hydrophilic face should be 100% hydrophilically-treated yarn.

In the above-described fabric provided by the present invention, the yarn that forms the hydrophobic face contains 60% to 99% hydrophobically-treated yarn and 1% to 40% hydrophilically-treated yarn. Or the yarn that forms the hydrophobic face can also be 100% hydrophobically-treated yarn.

The hydrophobic face of fabric that is knit from cotton yarn above-described also contains a certain amount of hydrophilic points (e.g., the hydrophilically-treated yarn in FIG. 1), which can transport water of the hydrophobic face to the hydrophilic face. The hydrophilic face has excellent hydrophilic characteristics. It can rapidly spread and evaporate water and sweat that are transported to it. It and the hydrophobic face together form an inner-outer differential that provides a motive force to convey water. By means of this characteristic, water and sweat can quickly penetrate from the hydrophobic face of a fabric to its hydrophilic face and then rapidly spread and evaporate. In this way, the effects of unidirectional transportation of water and quick drying are rapidly achieved. As a result, the hydrophobic face of the fabric remains dry and comfortable; it has moisture management and quick-drying functions. Garments that are made from such fabric are characterized by dry and comfortable wear, sweat absorption, and quick drying.

Therefore, in specific embodiments, said hydrophobic face can be formed entirely from hydrophobic yarn, and as a result of using appropriate knitting art, it will have small quantities of “hydrophilic points.” It is also possible to add, in accordance with different fabric structures, small quantities of hydrophilic yarn as appropriate to the hydrophobic yarn and thereby to ensure that water can be absorbed from the hydrophobic surface. As was described above, the yarn that forms the hydrophobic face contains at least a majority of hydrophobically-treated yarn. That is, the quantity of hydrophilic yarn that is added should be kept at or below 50%. Preferably, the yarn that forms the hydrophobic face contains 60% to 99% hydrophobically-treated yarn and 1% to 40% hydrophilically treated yarn. Said hydrophilic face is largely or entirely hydrophilically treated yarn. Ideally, it is 100% hydrophilically-treated yarn. Thus, water at the hydrophobic face is rapidly absorbed and diffused to the hydrophilic face of the fabric. Moreover, the fabric's characteristic, namely the difference in properties of its two faces, remains unaffected.

The fabric of the present invention can be knit by means of any known knitting method that can achieve unidirectional transportation of water and that is capable of forming two differently-propertied faces. That is, said fabric can be a double-knit fabric of various structures and patterns that is knit from the above-described pure cotton yarn, and it can be a single-knit plated fabric of various structures and patterns. For example, said fabric can be a rib fabric, a double-knit double-face fabric, a double-knit rib jacquard fabric, and all single knit plated fabrics. A single knit plated fabric can be, but is not limited to, a single-knit plated jersey fabric, a single-knit plated pique fabric, a single knit plated Lacoste fabric, or a single knit plated jacquard fabric.

Therefore, the present invention provides a quick-drying cotton fabric that is manufactured from 100% pure cotton materials and that integrates comfort with moisture management and quick-drying functions. Moreover, it has very good hand feel and superior comfort when worn.

In addition, the present invention also provides a method of producing said quick-drying pure cotton fabric with two differently-propertied faces. By means of unique treatment processes, cotton yarn undergoes different pretreatments that cause the two faces (inner and outer layers of a double-knit fabric) of the knitted pure cotton fabric each to have a different function, thereby achieving the special effects of unidirectional water transportation, comfortable wear, and enhanced moisture management and quick-drying.

The method of producing the quick-drying pure cotton fabric with two differently-propertied faces provided by the present invention comprises the following steps: Pure cotton yarn undergoes separate hydrophilic and hydrophobic treatments. The result is hydrophilically-treated yarn and hydrophobically-treated yarn. The two types of yarn then undergo the appropriate knitting process to become a fabric that can transport water unidirectionally and whose two faces have different properties.

Specifically, said hydrophilic treatment process that is used on the yarn according to the method provided by the present invention consists primarily of the following procedures: yarn dyeing, softening in bath, and drying.

1) In the procedure described above, the yarn dyeing process consists of the known procedures of scouring, dyeing, soaping, and fixation.

2) Said procedure of softening in bath consists of treating cotton yarn with a hydrophilic softener (also called hydrophilic softening oil). According to the present invention, cotton yarn is treated with a hydrophilic softener that is preferably selected from the group consisting of an aliphatic amine, an aliphatic amine derivative, an organic silicon, and a compound thereof. The organic silicon softener that it uses can be a polyether-modified organic silicon softener such as an organic silicon softener of polyether-modified epoxyethane or epoxypropane polymer. The softener is used in concentration of 1 to 10 grams per liter. The liquid ratio of said softener-containing treatment bath to the cotton yarn that is to be treated is between 1:5 and 1:10. Treatment takes from 10 to 50 minutes, and treatment temperature is from 30° C. to 100° C.

Because it contains hydrophilic groups, the above-described softener of the present invention can form hydrogen bonds with water molecules. Therefore, it has excellent wetting properties with respect to water. In addition, to improve penetration ability, one can add a polyoxyethylene ether compound, such as an ethyl aromatic fatty ether surfactant (PBN, etc.) or a fatty alcohol polyoxyethylene ether non-ionic surfactant (66-HK, etc.), as a penetration agent to the treatment bath. Generally, 1 to 5 grams of said penetration agent is used per liter of treatment bath.

During the treatment process, the cotton yarn must not be contaminated with other types of softeners, and the equipment involved should be cleaned carefully.

3) Treated cotton yarn is dried at approximately 80° C. to 150° C.

Said hydrophobic treatment process that is used on the yarn according to method of the present invention comprises dyeing the yarn, treating it with hydrophobic agent, and drying it.

In the procedure described above, the yarn dyeing consists of the known processes of scouring, dyeing, soaping, and fixation.

Preferably, the hydrophobic treatment is carried out between 40° C. and 100° C. for 5 to 60 minutes, with 1 to 100 g of hydrophobic agent used per liter.

The hydrophobic agent used in the present invention can be selected from the following: fatty acid amide, polycyanamide, organic silicon, or fluorocarbon hydrophobic agent. Specifically, said hydrophobic agent applied of the present invention can be selected from the group consisting of: hydroxymethyl fatty acid amide, etherified polyhydroxymethyl melamine, hydrosilicon oil emulsion, and organic fluorine emulsion. Said hydroxymethyl fatty acid amide hydrophobic agent is preferably a long-chain hydroxymethyl fatty acid amide. The preferred length of its carbon chain is from 14 to 28 carbons. Said hydrosilicon oil emulsion can be a hydrosilicon oil emulsion with cationic silicon, or it can be an active group-carrying polydimethylsiloxane hydrosilicon oil emulsion or a methyl hydrosilicon oil emulsion. Said organic fluorine emulsion is selected from the group consisting of a fluorine-containing alkyl acrylate copolymer emulsion, a fluororesin and a coordinated mixture of fluorocarbon and hydrocarbons.

After the cotton yarn that was treated with hydrophobic agent is directly dehydrated, it is dried at 100° C. to 180° C.

After one has employed the above-described methods to subject pure cotton yarn to separate hydrophilic and hydrophobic treatments, one can obtain hydrophilically-treated yarn and hydrophobically-treated yarn.

According to a scheme of the present invention after the above-described treatment, the two types of cotton yarn can be knitted undergoing a certain knitting process to become fabric. One face of the fabric (the hydrophilic face) is largely or entirely hydrophilic yarn, preferably 100% hydrophilic yarn. The other face (the hydrophobic face) is largely or entirely hydrophobic yarn, in which the proportion of hydrophilic yarn should not exceed 50% and preferably will be between 1% and 40%. The two faces of the fabric have essentially different properties. One face is hydrophilic, and the other face exhibits hydrophobicity. The fabric thus is comfortable and has moisture management and quick-drying functions. Any knitting method that can produce two differently-propertied faces of this type may be adopted. Specifically, knitting methods include, but are not limited to, a rib fabric knitting method, a double-knit double face knitting method, a double knit rib jacquard knitting method, a single-knit plated Jersey knitting method, a single-knit plated pique knitting method, a single-knit plated Lacoste knitting method, and a single-knit plated jacquard knitting method. Single-knit-structure (such as single-knit plated-structure) fabrics can be knit as necessary. One face is largely or entirely hydrophobically-treated pure cotton yarn, and the other face is largely or entirely hydrophilically-treated yarn. The entire fabric will possess both hydrophilic and hydrophobic properties, resulting in unidirectional transportation of water. The specific knitting techniques are the well-known art commonly used in this field and will not be described further here.

To improve the quality of products of the present invention further, one may apply appropriate after-treatment procedures. For example, one may selectively perform such procedures as mercerization, enzyme wash, or resin finishing to cause the fabric to have, in addition to its moisture-absorption and quick-dry properties, such characteristics as good shape retention, dimensional stability, and pilling resistance.

Said resin finishing may consist of using a mixture of a resin, a catalyst, and a penetration agent to treat the fabric or garment. For example, said resin in the mixture can be a compound such as dimethoxyethylene urea (DMEU), dimethyloldihydroxyethylene urea (DMDHEU), dimethylpropylene urea (DMPU), dihydroxymethyltriazone (DMT), or modified N-methyldihydroxyethyl urea or a modification thereof such as modified dimethyloldihydroxyethylene urea resin. Approximately 20-150 grams of resin is used to make one liter of the mixture. Said catalyst can be magnesium salt, nitrate, or zinc fluoborate. Approximately 5-30 grams of catalyst is used to make one liter of the mixture. Said penetration agent can be a polyethenoxy ether compound such as an ethyl aromatic fatty ether surfactant (such as PBN) or an aliphatic alcohol polyoxyethylene ether non-ionic surfactant (such as 66-HK). Approximately 0.5-4 grams of penetration agent is used to make one liter of the mixture. The temperature for the resin finishing is generally 140° C. to 180° C. Approximately 1-4 minutes should be sufficient for the resin finishing at this temperature.

By using an above-described process such as resin finishing, mercerization, or enzyme wash, one can maintain the shape retention and clean fabric surface of washed fabric and thereby improve the appearance and durability of the fabric.

All of the technologies that are currently used to produce moisture management fabrics are based on the fabric finishing process. This process cannot achieve different properties between the two faces of the fabric and thus cannot produce the unidirectional water transportation function. In addition, the quick-drying fabrics in the current art are primarily found among synthetic fiber and cotton-synthetic fiber blended products. There still has not been any report of a pure cotton product. The fabric of the present invention, by means of the difference between the two faces, achieves actually unidirectional transportation of water or sweat through pure cotton fabric, and produces the effects of dry comfort and quick-drying. In particular, the present invention uses special cotton yarn treatment processes and uses appropriate knitting processes to endow the same fabric with two different properties: a hydrophilic property and a hydrophobic property (One face is entirely hydrophilic and absorbent. It is good for absorbing water. The other face is hydrophobic and draws water away and thus keeps the fabric dry and comfortable.). With the difference between its two faces, the fabric can ensure unidirectional transportation of water and can guarantee that knit materials (fabrics) are not subject to mutual effects during subsequent processes (particularly washing, mercerizing, and resin finishing processes) or during home laundering processes and that it will maintain certain durability throughout.

To summarize the above, the present invention has the following advantages over the current art:

1. Different treatment methods are used to perform separate hydrophilic and hydrophobic treatments of pure cotton yarn and thereby to obtain the yarn with two different natures. The two kinds of yarn are knit according to a certain knitting process. One face of the resulting fabric is largely or entirely formed from hydrophobic pure cotton yarn; it is highly permeable to moisture and air. The other face is largely or entirely formed from hydrophilic pure cotton yarn; it has excellent water absorption and spreading properties. The difference between hydrophilic face and the hydrophobic face provides a motive force for transportation of water. Water or sweat can be very quickly transported from the hydrophobic face to the hydrophilic face. The hydrophobic face thus remains dry and comfortable, and moisture management and quick-drying functions are thereby achieved.

2. The fabric makes use of 100% pure cotton material which, when finished, has a very good hand feel and provides superior comfort when worn.

3. The selected hydrophilic softener and hydrophobic agent have good durability. This ensures the durability of the unidirectional transportation function. After the fabric of the present invention undergoes 10 or more home launderings in accordance with AATCC 143 laundering methods, it retains superior unidirectional water transportation and quick-drying functions.

4. The fabric of present invention has excellent durability. When laundered in accordance with AATCC 143 methods, it can undergo 10 or more home launderings (the typical launderability standard for products now requires it to withstand 5 launderings) and still maintain good wearability. Furthermore, color fading is minimal after laundering. Compared to the current art, the change in coloration (fading) of the fabric of the present invention after 10 launderings can be kept at level 3.5 or higher (when tested according to the AATCC 143 method).

### BRIEF DESCRIPTION OF THE DRAWING

FIG. 1 is a schematic drawing of the water transportation effects of the quick-drying pure cotton fabric with two differently-propertied faces of the present invention.

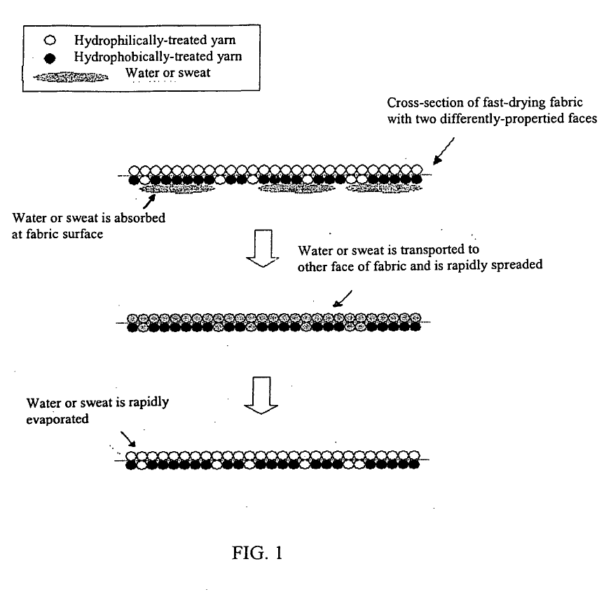

### DETAILED DESCRIPTION OF THE PREFERRED EMBODIMENTS

We shall provide a detailed discussion below on schemes and results of the present invention in light of specific embodiments, but we do not in any way restrict the scope of exploitation of the present invention.

### Embodiment 1: 60s/2 Double-Knit Double-Face Fabric The method of producing the 60s/2 double-knit double-faced-structure fabric of the present embodiment:

1. Treatment of Pure Cotton Yarn:

a. The Process of Hydrophilic Treatment and Dyeing Cotton Yarn:

Scouring→Dyeing→Soaping, fixation→Softening in bath (hydrophilic softener)→Drying.

1) Scouring, dyeing, soaping, and fixation are performed according to normal workshop processes.

2) The polyether-modified epoxyethane organic silicon softener Magnasoft HWS (from GE Corp.) is used as the hydrophilic softener. 4 grams are used per liter. The treatment lasts 30 minutes at 30° C. The liquid ratio is around 1:10.

3) The treated cotton yarn is dried at 120° C.

b. The Process of Hydrophobic Treatment and Dyeing Cotton Yarn:

Scouring→Dyeing→Soaping, fixation→Treating with hydrophobic agent→Drying.

1) Scouring, dyeing, soaping, and fixation are performed according to normal processes.

2) The hydrophobic treatment is done at 90° C. for 8 minutes with hydroxymethyl stearamide-type hydrophobic softening oil Polysofter CAM-100 (produced by Seki Chemical Co. in Taiwan), approximately 80 grams of Polysofter CAM-100 are used for one liter of treatment bath.

3) Dehydrate cotton yarn that has been treated with hydrophobic agent, and dry it at 150° C.

2. Knitting Processes

Use a double-knit double-face knitting method to knit the above-described treated cotton yarn into a double-layer-structure pure cotton fabric, wherein one layer is a hydrophobic layer knit from hydrophobically-treated yarn, and the other layer is a hydrophilic layer knit from hydrophilically-treated yarn.

3. Resin Finishing

Resin finishing is accomplished with a mixture of a resin, a catalyst, and a penetration agent.

The resin is dimethyloldihydroxyethylene urea (DMDHEU) Fixapret CP (produced by BASF Corp.), 120 grams of which are used per liter. The catalyst is MgCl₂ (24 g/L), and the penetration agent is PBN (4 g/L).

Resin finishing is accomplished at 140° C.

The above-described steps were completed to obtain the 60s/2 double-layer-structure fabric of the present embodiment. Its performance was tested in accordance with the M&S P136B method, and the results were recorded in Table 1:

TABLE 1

| | | 30-minute Evaporation Rate | |
|---|---|---|---|
| | | (M&S P136B Method) | |
| | | | After 20 |
| | | Before washing | washings |
| Ordinary pure | 20s/1 pique | 15.9 | 13.0 |
| cotton fabric | | | |
| Quick-drying pure | 60s/2 double-knit | 20.7 | 22.6 |
| cotton fabric with | double-face fabric | | |
| two differently- | | | |
| propertied faces | | | |

The data in the above table 1 show that the water evaporation rate of the quick-drying pure cotton fabric with two differently-propertied faces of the present invention is much higher than that of an ordinary pure cotton fabric. Thus, when the human body perspires, the sweat can be quickly absorbed and transported to the outer surface of the fabric, where it evaporates.

### Embodiment 2: 60s/2 Double-Knit Rib Jacquard Fabric

The method of producing 60s/2 double-knit rib jacquard fabric of the present embodiment is as follows:

1. Treatment of Mercerized Cotton Yarn:

a. The Process of Hydrophilic Treatment and Dyeing Mercerized Cotton Yarn:

Scouring→Dyeing→Soaping, fixation→Softening in bath (hydrophilic softener)→Drying.

1) Scouring, dyeing, soaping, and fixation are performed according to normal workshop processes.

2) 8 grams of high-grade aliphatic amine and organic silicon compound softener Ultraphil HMS (produced by CIBA Corp.) are used per liter. The treatment lasts 10 minutes at 40° C.

3) The treated cotton yarn is dried at 100° C.

b. The Process of Hydrophobic Treatment and Dyeing Mercerized Cotton Yarn:

Scouring→Dyeing→Soaping, fixation→Treating with hydrophobic agent→Drying

1) Scouring, dyeing, soaping, and fixation are done according to normal processes.

2) The hydrophobic treatment is done at 70° C. for 20 minutes with the fluorocarbon compound Olephobol CO (CIBA Corp.) as the hydrophobic agent. Approximately 20 grams of hydrophobic agent are used per liter of treatment bath.

3) Dehydrate cotton yarn that has been treated with hydrophobic agent, and dry it at 120° C.

2. Knitting Processes

Use a double-knit rib jacquard knitting method to knit the above-described treated mercerized cotton yarn into double-layer-structure pure cotton fabric, wherein one layer is a hydrophobic layer knit from hydrophobically-treated yarn (alternatively, the hydrophobic layer contains about 10% hydrophilic-treated yarn), and the other layer is a hydrophilic layer knit from hydrophilically-treated yarn.

3. Resin Finishing

Resin finishing is accomplished with a mixture of a resin, a catalyst, and a penetration agent.

The resin used is modified 2D resin FR—Cl, 80 grams of which are used per liter. The catalyst is MgCl₂ (16 g/L), and the penetration agent is 66-HK (2 g/L).

Resin finishing is accomplished at about 180° C.

The above-described steps were completed to obtain the 60s/2 rib jacquard fabric of the present embodiment. Its properties were tested in accordance with the M&S P136B method, and the results were recorded in Table 2:

TABLE 2

| | | 30-minute Evaporation Rate | |
|---|---|---|---|
| | | (M&S P136B Method) | |
| | | | After 20 |
| | | Before washing | washings |
| Ordinary pure | 20s/1 pique | 15.9 | 13.0 |
| cotton fabric | | | |
| Quick-drying pure | 60s/2 double-knit | 22.6 | 21.7 |
| cotton fabric with | rib jacquard | | |
| two differently- | | | |
| propertied faces | | | |

The data in the above table 2 show that the water evaporation rate of the quick-drying pure cotton fabric with two differently-propertied faces of the present embodiment is much higher than that of an ordinary pure cotton fabric. Thus, when the human body perspires, the sweat can be quickly absorbed and transported to the outer surface of the fabric, where it evaporates.

### Embodiment 3: 60s/2 Single-Knit Plated Jersey/Pique Fabric

The method of producing 60s/2 single-knit plated jersey/pique fabric of the present embodiment is as follows:

1. Treatment of Cotton Yarn:

a. The Process of Hydrophilic Treatment and Yarn Dyeing:

Scouring→Dyeing→Soaping, fixation→Softening in bath (hydrophilic softener)→Drying.

1) Scouring, dyeing, soaping, and fixation are performed according to normal workshop processes.

2) 2 grams of softener JH-PPE200A1 5 (an organic silicon softener from Jen Hsiang Chemical Industrial Co., Ltd.) are used per liter. The treatment lasts 40 minutes at 50° C.

3) The treated cotton yarn is dried at about 140° C.

b. The Process of Hydrophobic Treatment and Dyeing Cotton Yarn: Scouring→Dyeing→Soaping, fixation→Treating with hydrophobic agent→Drying.

1) Scouring, dyeing, soaping, and fixation are done according to normal processes.

2) The hydrophobic treatment is done at 50° C. for 40 minutes with nanofluoropolymers, approximately 5 grams of hydrophobic agent per liter of treatment bath.

3) Dehydrate cotton yarn that has been treated with hydrophobic agent, and dry it at 160° C.

2. Knitting Processes

Use a single-knit plated jersey/pique knitting method. One face is 70% hydrophobically-treated yarn and 30% hydrophilically-treated yarn, and the other face is 100% hydrophilically-treated yarn. They are knit into a single-layer pure cotton fabric whose two faces have different properties.

3. Resin Finishing

Resin finishing is accomplished with a mixture of a resin, a catalyst, and a penetration agent.

The resin is dimethyloldihydroxyethylene urea (DMDHEU) CP, about 30 grams of which are used per liter. The catalyst is MgCl₂ (about 6 g/L), and the penetration agent is aliphatic alcohol polyoxyethylene ether non-ionic surfactant 66-HK (about 2 g/L).

Resin finishing is accomplished at about 160° C.

The above-described steps were completed to obtain the 60s/2 and 40s/1 single-knit plated jersey or single-knit plated pique fabric of the present embodiment. Their properties were tested in accordance with the M&S P136B method, and the results were recorded in Table 3:

TABLE 3

| | | 30-minute Evaporation Rate | |
|---|---|---|---|
| | | (M&S P136B Method) | |
| | | | After 20 |
| | | Before washing | washings |
| Ordinary pure | 20s/1 pique | 15.9 | 13.0 |
| cotton fabric | | | |
| Quick-drying pure | 40s/1 single-knit | 21.0 | 24.6 |
| cotton fabric with | plated jersey fabric | | |
| two differently- | | | |
| propertied faces | | | |
| | 60s/2 single-knit | 21.0 | 22.6 |
| | plated pique fabric | | |

The data in the above table show that the water evaporation rate of the quick-drying pure cotton fabric with two differently-propertied faces of the present embodiment is much higher than that of an ordinary pure cotton fabric. Thus, when the human body perspires, the sweat can be quickly absorbed and transported to the outer surface of the fabric, where it evaporates.

According to specific embodiments of the present invention, feasible methods of producing durable quick-drying pure cotton fabrics whose two faces have different properties may selectively comprise the steps below: (1) yarn mercerizing, (2) yarn scouring, (3) enzyme washing, (4) particular yarn dyeing, (5) particular knitting, (6) fabric mercerizing, (7) resin finishing, (8) garment making, and (9) garment washing. The application of such processes as mercerization, enzyme washing, and resin finishing can maintain the fabric's appearance after washing and thereby improve its appearance and durability.

1. A quick-drying pure cotton fabric with two faces having different properties, the first face of said fabric being a hydrophobic face formed largely or entirely from hydrophobic pure cotton yarn and the second face being a hydrophilic face largely or entirely formed from hydrophilic pure cotton yarn, said fabric being capable of unidirectional transportation of water.

2. The quick-drying pure cotton fabric as described in claim 1, wherein said fabric has a single-knit or a double-knit structure.

3. The quick-drying pure cotton fabric as described in claim 1, wherein the yarn used to form the hydrophobic face contains from 60% to 100% hydrophobically-treated yarn and from 0% to 40% hydrophilically-treated yarn, and the yarn used to form the hydrophilic face is 100% hydrophilically-treated yarn.

4. The quick-drying pure cotton fabric as described in claim 3, wherein the yarn that forms the hydrophobic face contains 60% to 99% hydrophobically-treated yarn and 1% to 40% hydrophilically-treated yarn.

5. The quick-drying pure cotton fabric as described in claim 3, wherein the yarn that forms the hydrophobic face contains 100% hydrophobically-treated yarn.

6. The quick-drying pure cotton fabric as described in claim 1, wherein said fabric is a double-knit fabric or a single-knit plated fabric knit from said pure cotton yarn.

7. The quick-drying pure cotton fabric as described in claim 2, wherein said fabric is a double-knit fabric or a single-knit plated fabric knit from said pure cotton yarn.

8. The quick-drying pure cotton fabric as described in claim 3, wherein said fabric is a double-knit fabric or a single-knit plated fabric knit from said pure cotton yarn.

9. The quick-drying pure cotton fabric as described in claim 4, wherein said fabric is a double-knit fabric or a single-knit plated fabric knit from said pure cotton yarn.

10. The quick-drying pure cotton fabric as described in claim 5, wherein said fabric is a double-knit fabric or a single-knit plated fabric knit from said pure cotton yarn.

11. A pure cotton garment made from the quick-drying pure cotton fabric as described in claim 1.

12. A method of producing a quick-drying pure cotton fabric, comprising the following steps:
hydrophilically treating pure cotton yarn to obtain hydrophilically-treated yarn;
hydrophobically treating pure cotton yarn to obtain hydrophobically-treated yarn; and
knitting the hydrophilically-treated yarn and the hydrophobically-treated yarn to make a fabric that has a hydrophobic face formed largely or entirely from the hydrophobically-treated pure cotton yarn and a hydrophilic face largely or entirely formed from the hydrophilically-treated pure cotton yarn such that the fabric can unidirectionally transport water.

13. The method as described in claim 12, wherein the step of hydrophilically treating said cotton yarn comprises dyeing the yarn, softening the yarn in a bath with a hydrophilic softener, and drying it.

14. The method as described in claim 13, wherein said hydrophilic softener in said softening step is selected from the group consisting of aliphatic amines, aliphatic amine derivatives, organic silicon compounds, and a mixture thereof.

15. The method as described in claim 14, wherein the hydrophilic softener is used in a concentration of 1-10 grams per liter and said treatment with the hydrophilic softener is carried out for 10-50 minutes at 30° C.-100° C.

16. The method as described in claim 13, wherein said drying step comprises drying the cotton yarn at 80° C.-150° C.

17. The method as described in claim 12, wherein said step of hydrophobically treating the cotton yarn comprises dyeing the yarn, treating it with a hydrophobic agent, and drying it.

18. The method as described in claim 17, wherein said step of treating the yarn with a hydrophobic agent is carried out at 40-100° C. for 5-60 minutes with a hydrophobic agent in an amount from 1-100 g/L.

19. The method as described in claim 17, wherein said hydrophobic agent in said treating step is selected from the group consisting of aliphatic acid amides, polycyanamides, organic silicon compounds, fluorocarbon hydrophobic softening oils, and mixtures thereof.

20. The method as described in claim 19, wherein said hydrophobic agent is selected from the group consisting of hydroxymethyl aliphatic acid amide, etherified polyhydric melamine, hydrosilicon oil emulsion, and organic fluorine emulsion.

21. The method as described in claim 20, wherein the said hydrosilicon oil emulsion is selected from the group consisting of a hydrosilicon emulsion with cationic silicon, an active group-carrying polydimethylsiloxane hydrosilicon oil emulsion, and a methyl hydrosilicon oil emulsion; and said organic fluorine emulsion is selected from the group consisting of a fluorine-containing alkyl acrylic ester copolymer emulsion, a fluororesin, and a coordinated mixture of fluorocarbons and hydrocarbons.

22. The method as described in claim 17, wherein said drying step comprises drying the yarn at a temperature of 100° C. to 180° C.

23. The method as described in claim 12, wherein said knitting step comprises knitting the fabric using a double-knit double-faced knitting method, a double-knit rib jacquard knitting method, or a single-knit structure knitting method.

24. The method as described in claim 23, wherein said single-knit plated-structure knitting method comprises a single-knit plated jersey knitting method, a single-knit plated pique knitting method, a single-knit plated Lacoste knitting method, or a single-knit plated jacquard knitting method.

25. The method as described in claim 12, further comprising the step, after said knitting step, of after-treating the fabric using a procedure selected from the group consisting of mercerization, enzyme washing, resin finishing, garment making, and garment washing.
